(19) United States
(12) Patent Application Publication
(10) Pub. No.: US 2025/0231602 A1
(43) Pub. Date: Jul. 17, 2025

(54) PORTABLE ENTERPRISE COMPUTING CLUSTER

(71) Applicant: Derric Borthwick, Fredericksburg, VA (US)

(72) Inventor: Derric Borthwick, Fredericksburg, VA (US)

(73) Assignee: Datastem Technologies Inc., Fredericksburg, VA (US)

(21) Appl. No.: 18/411,008

(22) Filed: Jan. 11, 2024

(51) Int. Cl. G06F 1/26

(52) U.S. Cl. CPC G06F 1/26

(57) ABSTRACT

The arrangement and composition of elements herein describe an enterprise-level cloud computing capability having a small and portable form factor. This highly capable and portable system is made possible through the combination of high-density computing elements, storage elements, networking elements, cooling elements, and power distribution elements in a single unit that result in a system able to be carried by one person. This portable system therefore affords the functionality and capability of an enterprise cloud server stack where space and/or physical infrastructure limitations prevent the utilization of traditional on-prem cloud server racks typically housed in a remote server rack farm or data center. In addition to the privacy and security benefits of an on-premises enterprise cloud capability, this also provides processing, storage, and networking mobility, as the unit can more easily and quickly be moved from location to location and without the need for server rack equipment.

### BACKGROUND/SUMMARY

### BACKGROUND OF THE INVENTION

The invention herein pertains to the field of server infrastructure; more specifically, compact, portable cloud servers in the form of compute clusters.

The convenience and availability of cloud services has dramatically lowered the barrier to infrastructure accessibility and hence the advent of platforms such as Amazon Web Services, Azure, and Google Cloud among others.

The ability to deploy virtual machines and/or services on one of these platforms eliminates the need for maintaining the infrastructure the services are deployed, primarily due to the cost prohibitive nature of server rack-based infrastructure and operating requirements. This financial barrier primarily relates to the extensive list of requirements that include the physical space, space cooling, bare-metal equipment, equipment configuration, equipment maintenance, physical security, etc.

Modern proliferation of cloud-based services available on current platforms have also benefitted greatly from complimentary advances in software virtualization capabilities, including concepts such as ‘containerization’, and ‘Infrastructure as Code’. Similarly, innovation in chip manufacturing methods has greatly contributed to the miniaturization and complexity of electronic components and integrated circuits. Ultimately, it is a combination of this higher density compute capability and improved virtualization methods that form the basis of the proposed invention.

As of late, personal computers have seen a reduction in size without compromise in compute capability, but this has yet to be seen in new server tech. In other words, server specifications improve, but form factor does not. The ubiquitous nature of server form factors and infrastructure (rack size and arrangement) do not incentivize or necessitate any change because of that. Therefore, in order to improve upon current server form factor standards and capability, the invention herein combines the elements of a typical enterprise server stack and fits it into a small, portable form factor that can be carried by a single person.

### SUMMARY OF THE INVENTION

Ultimately, the invention is a portable computing cluster and all the components that comprise the cluster into one single package that is as compact as is possible. A typical embodiment of the invention, for example, will include multiple compute elements, data storage elements, networking elements, power supply elements, and cooling elements, all together, in a single package. This is very similar to the concept of a typical desktop computer or server rack that has compute, storage, networking, power, and cooling, except the invention herein includes two or more separate CPU carrying boards, or multiple boards with clusters of CPUs, and in either case, also includes all the networking elements required to connect them. Essentially, it is multiple computers and/or servers together that make a larger computing cluster, but in a compact, singly contained arrangement.

### DESCRIPTION

### BRIEF DESCRIPTION OF THE DRAWINGS

FIG. 1: Pictured is the representation of the external case containing all components.

FIG. 2: Pictured is an exploded view of internal components with the case removed.

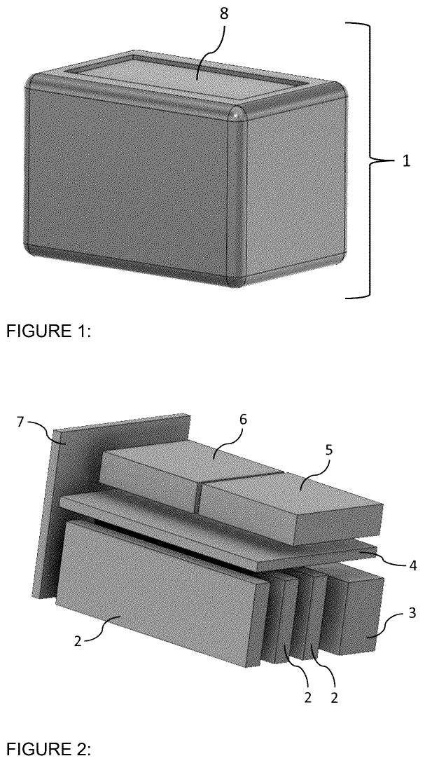

### DETAILED DESCRIPTION

The embodiment described herein represents a single arrangement and is not comprehensive, nor is it limiting or representative in whole of what is being claimed.

In the simplest embodiment, the invention consists of all the necessary constituent elements to form a computing cluster, all in one compact and carriable unit that make up the invention. For reference, the approximate dimensions of the external case 1 is 10 inches wide, by 15 inches deep, by 11 inches high. In this example depicted by the drawings, the main host computing element 7 is a mini-ITX form factor server mother board with a server chip, server RAM, and solid-state drive for containing the operating system and extra disk storage. This host computing element 7 communicates with the secondary computing elements 2 over the main networking element 4; in this case an ethernet network switch.

The secondary computing elements 2 are themselves compute clusters that contain multiple CPU's and a networking switch-on-chip to facilitate communication with the host controller 7 and the rest of the computing elements 2 that are all connected to the main ethernet network switch 4. In another embodiment, the secondary computing elements 2 could just be single board computers.

IP allocation and network management are accomplished via DHCP server which is also installed on the host computing element 7. Convection cooling is achieved with the box fans 5-6 moving air through the opening in the top of the case 8 and everything is powered with an array of 12v DC buck converters or in this case, an 120/240 VAC power supply 3. In this arrangement, the system can operate with either hardware virtualization or software virtualization. For example, the ESXi VMware vSphere™ Hypervisor could be installed on all secondary computing elements 2 and host computing element 7 to serve as a bare metal hypervisor with which resources could be allocated to build out a desired infrastructure stack for a given purpose. On the other hand, software virtualization can be used to a similar end where a Linux kernel is installed on all compute and host controller elements, upon which a Kubernetes cluster is constructed from the host controller 7 as the control plane and all secondary computing elements 2 as workers. Here, services can be deployed, and resources allocated via pods on the Kubernetes cluster.

1. A portable, rackless, low power compute cluster with high compute density comprising: a plurality of compute elements connected over a network through a plurality of networking elements, where each said compute element has a plurality storage elements, a plurality of memory elements, and at least one networking interface to connect to said networking elements; at least one processing element per compute element; a plurality of power distribution elements powering all said elements requiring such; a plurality of cooling elements; a single enclosure wherein all said elements are contained.

2. A portable, rackless, low power compute cluster with high compute density as in claim 1, wherein the said compute element network interfaces are combination of wireless, fiber optical, ethernet, and ethernet over USB.

3. A portable, rackless, low power compute cluster with high compute density as in claim 1, wherein the said cluster has a total mass less than 50 pounds, total power consumption is less than 1,000 peak watts, and total volume is less than 3,600 cubic inches.

4. A portable, rackless, low power compute cluster with high compute density as in claim 1, wherein at least one of the said compute elements serves as a control plane for orchestrating the resource management for either hardware or software-based hypervisor configurations for the said cluster.

5. A portable, rackless, low power compute cluster with high compute density as in claim 1, wherein each said processing element has at least 8 computing cores.

6. A portable, rackless, low power compute cluster with high compute density as in claim 1, further comprising at least one network access port and at least one power supply port externally accessible through said cluster enclosure.

7. A portable, rackless, low power compute cluster with high compute density as in claim 1, wherein the arrangement of said power distribution elements permit input power to be either direct current or alternating current.

8. A portable, rackless, low power compute cluster with high compute density as in claim 1, wherein the total volume of said cluster is 12 cubic inches per said computing core or less.

9. A portable, rackless, low power compute cluster with high compute density as in claim 1, wherein the said compute element network interfaces are wireless.

10. A portable, rackless, low power compute cluster with high compute density as in claim 1, wherein the said compute element network interfaces are ethernet.

11. A portable, rackless, low power compute cluster with high compute density as in claim 1, wherein the said compute element network interfaces are ethernet over USB.

12. A portable, rackless, low power compute cluster with high compute density as in claim 1, wherein the said compute element network interfaces are fiber optic.

13. A portable, rackless, low power compute cluster with high compute density as in claim 1, wherein said cooling elements are passive heatsinks.

14. A portable, rackless, low power compute cluster with high compute density as in claim 1, wherein said cooling elements are liquid coolant based.

15. A portable, rackless, low power compute cluster with high compute density as in claim 1, wherein said cooling elements are active cooling fans.

16. A portable, rackless, low power compute cluster with high compute density as in claim 1, wherein said cooling elements are Peltier heat pumps.

17. A portable, rackless, low power compute cluster with high compute density as in claim 1, wherein said cooling elements are a combination of passive heatsinks, liquid cooling, active cooling fans, and Peltier heat pumps.
